(19) United States
(12) Patent Application Publication
(10) Pub. No.: US 2015/0128095 A1
(43) Pub. Date: May 7, 2015

(54) METHOD, DEVICE AND COMPUTER SYSTEM FOR PERFORMING OPERATIONS ON OBJECTS IN AN OBJECT LIST

(71) Applicant: Tencent Technology (Shenzhen) Company Limited, Shenzhen (CN)

(72) Inventor: Gang CHENG, Shenzhen (CN)

(21) Appl. No.: 14/483,041

(22) Filed: Sep. 10, 2014

Related U.S. Application Data
(63) Continuation of application No. PCT/CN2014/079583, filed on Jun. 10, 2014.

(30) Foreign Application Priority Data
Nov. 7, 2013 (CN) 201310549799.5

(51) Int. Cl. G06F 3/0484; G06F 3/0488

(52) U.S. Cl. CPC G06F 3/04847; G06F 3/04883
USPC 715/863

(57) ABSTRACT

The present application discloses methods, devices and computer systems for performing operations on objects in an object list. After detecting a swipe gesture on the touch screen, a computer system, e.g. a smart phone, can identify a target object of the swipe gesture. The computer system can also determine the direction of the swipe gesture and a preset operation corresponding to the direction. If the swiping distance of the swipe gesture is sufficiently long, the identified operation is performed on the target object without additional confirmation from the user. Different directions of the swipe gesture result in different operations that are of different nature. A warning message can be displayed when the swiping distance of the swipe gesture is greater than a threshold value.

### RELATED APPLICATIONS

This application is a continuation application of PCT Patent Application No. PCT/CN2014/079583, entitled “METHOD, DEVICE AND COMPUTER SYSTEM FOR PERFORMING OPERATIONS ON OBJECTS IN AN OBJECT LIST” filed on Jun. 10, 2014, which claims priority to Chinese Patent Application No. 201310549799.5, “Method, Device and Computer system for Performing Operations on Objects in an Object List,” filed on Nov. 7, 2013, both of which are hereby incorporated by reference in their entirety.

### FIELD OF THE TECHNOLOGY

The present application generally relates to communication technology, in particular to method, device and computer system for performing operations on objects in an object list.

### BACKGROUND

With the development of communication technology, more and more client terminals, e.g. smart phones and tablet computers, are being used in everyday life, bringing much needed convenience to people. To display more contents in a client terminal, sometimes object lists, which may include a number of objects, are used. The user can manage the objects in the object list by performing certain kinds of operations on the objects. For example, the objects can be deleted, saved, and re-positioned to the top of the list. If operations can be performed swiftly on the objects, the object list can be managed more efficiently.

To perform certain operations to an object, the existing technology usually includes two steps: first, identifying the object and the operation to be performed; and second, requesting a confirmation, e.g. with a dialog box, from the user regarding whether the operation should be performed. If the user provides the confirmation, then the operation is performed to the object. For example, when an object in an object list is selected to be deleted, a dialog box is displayed and requests confirmation from the user; after the user provides the confirmation, the deletion operation is performed and the object is deleted from the list.

The inventors found at least the following problems for the existing technology: since the existing technology requests at least two step before the operation can be performed, the entire process is cumbersome and the efficiency to manage the objects is low, negatively impacting user experience.

### SUMMARY

The above deficiencies and other problems associated with the existing technology are reduced or eliminated by the application disclosed below. In some embodiments, the application is implemented in a computer system that has one or more processors, memory and one or more modules, programs or sets of instructions stored in the memory for performing multiple functions. Instructions for performing these functions may be included in a computer program product configured for execution by one or more processors.

One aspect of the application involves a computer-implemented method performed by a computer system. The computer system may detect a swipe gesture on the touch screen, the swipe gesture including a starting point on the touch screen and an ending point on the touch screen. In response to detecting the swipe gesture, the computer system may identify, among a list of objects, an object based on the starting point of the swipe gesture. In addition, the computer system may identify a direction of the swipe gesture on the touch screen and a preset operation corresponding to the direction and measure a distance of the swipe gesture between the starting point and the ending point. The computer system may perform a first operation if the distance is longer than a first preset value and the direction of the swipe gesture is in a first direction and a second operation if the distance is longer than the first preset value and the direction of the swipe gesture is in a second direction opposite the first direction, wherein the first operation and the second operation are of different natures.

Another aspect of the application involves a computer system. The computer system includes memory, one or more processors, and one or more program modules stored in the memory and configured for execution by the one or more processors. The one or more program modules include: a detection module configured to detect a swipe gesture on the touch screen, the swipe gesture including a starting point on the touch screen and an ending point on the touch screen; an identification module configured to identify, among a list of objects, an object based on the starting point of the swipe gesture, and a direction of the swipe gesture on the touch screen and a preset operation corresponding to the direction, in response to detecting the swipe gesture; a measuring module configured to measure a distance of the swipe gesture between the starting point and the ending point; and a performing module configured to perform a first operation if the distance is longer than a first preset value and the direction of the swipe gesture is in a first direction and a second operation if the distance is longer than the first preset value and the direction of the swipe gesture is in a second direction opposite the first direction, wherein the first operation and the second operation are of different natures.

Another aspect of the application involves a non-transitory computer readable storage medium having stored therein instructions, which when executed by a computer system cause the computer system to: detect a swipe gesture on the touch screen, the swipe gesture including a starting point on the touch screen and an ending point on the touch screen; in response to detecting the swipe gesture: identify, among a list of objects, an object based on the starting point of the swipe gesture; identify a direction of the swipe gesture on the touch screen and a preset operation corresponding to the direction; and measure a distance of the swipe gesture between the starting point and the ending point; and perform a first operation if the distance is longer than a first preset value and the direction of the swipe gesture is in a first direction and a second operation if the distance is longer than the first preset value and the direction of the swipe gesture is in a second direction opposite the first direction, wherein the first operation and the second operation are of different natures.

Some embodiments may be implemented on either the client side or the server side of a client-server network environment.

### BRIEF DESCRIPTION OF THE DRAWINGS

The aforementioned features and advantages of the application as well as additional features and advantages thereof will be more clearly understood hereinafter as a result of a detailed description of preferred embodiments when taken in conjunction with the drawings.

FIG. 1 is a flowchart illustrative of a method for performing operations on an object in accordance with some embodiments of the current application.

FIGS. 2A, 2B and 2C are sample screen shots illustrative of performing an operation on an object based on a swipe gesture in accordance with some embodiments of the current application.

FIG. 3 is a flowchart illustrative of a method for performing operations on an object in accordance with some embodiments of the current application.

FIGS. 4A, 4B and 4C are sample screen shots illustrative of performing an operation on an object based on a swipe gesture in accordance with some embodiments of the current application.

FIGS. 5A, 5B and 5C are sample screen shots illustrative of performing an operation on an object based on a swipe gesture in accordance with some embodiments of the current application.

FIG. 6 is a block diagram illustrative of a computer system that can be used in performing an operation on an object based on a swipe gesture in accordance with some embodiments of the current application.

FIG. 7 is a block diagram of a computer system in accordance with some embodiments of the current application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

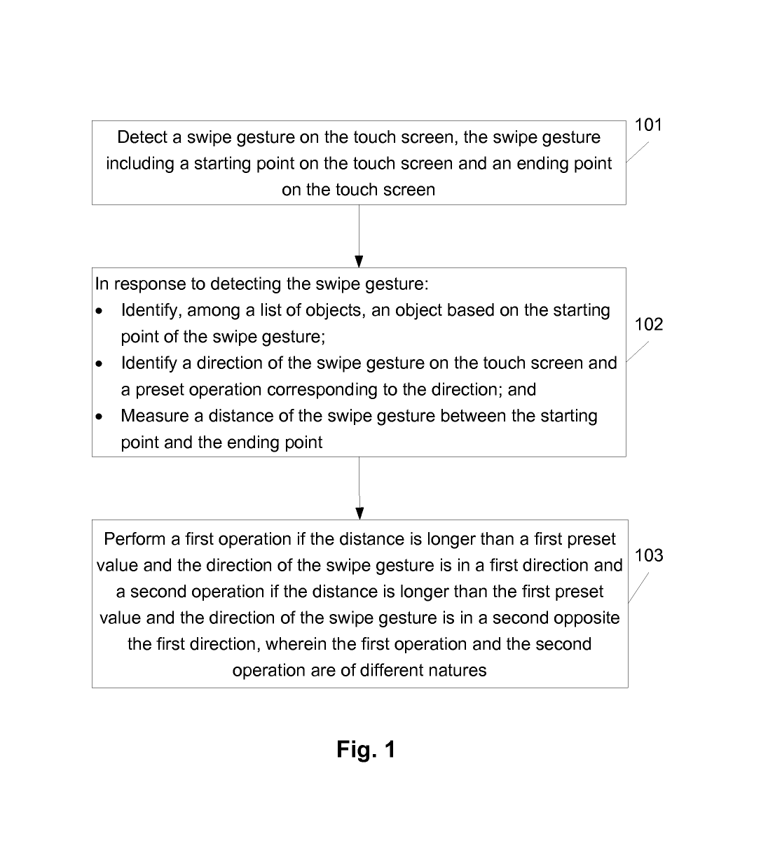

FIG. 1 is a flowchart illustrative of a method for performing operations on an object in accordance with some embodiments of the current application. For illustrative purposes, the current method may be implemented for objects in an object list, which can be used in any kind of applications such as a social networking or communication program, an on-line game application, or a shopping program running at a computer system.

According to FIG. 1, step 101, the computer system can detect a swipe gesture on the touch screen, the swipe gesture including a starting point on the touch screen and an ending point on the touch screen.

The computer system can be any device having computational capabilities. For example, the computer system may be servers, workstations, personal computers such as laptops and desktops, and mobile devices such as smart phones and tablet computers. The computer system may also include multiple computing devices functionally integrated to process and verify interaction information. In some embodiments, the computer system has a touch screen, which is an electronic visual display that the user can control through touching the screen—touch gestures. The touch gestures can be conducted with a special device such as a touch pen or with the user's fingers. The touch screen can be used as a display device and the user can use the touch screen to conduct certain operations and control objects that are displayed on the touch screen.

A swipe gesture refers to gestures conducted on a touch screen that includes a touch-move-release process. The swipe gesture may include a starting point, which can be the point on the touch screen resulted from the initial touch. The starting point corresponds to starting coordinates. When the user touches the screen and moves the point of touch—the instant point—without releasing, the corresponding coordinates of the instant point are changing with the movement. When the distance between the instant point and the starting point surpasses a threshold value, the gesture can be considered a swipe gesture, which also has an ending point—the point where the touch device, e.g. finger, leaves the touch screen. In some embodiments, the ending point is the point where the touch device is lifted from the screen. In some embodiments, the ending point is the point where the swipe reaches the boarder of the screen and moves beyond the boarder.

When the computer system detects a swipe gesture, the computer system receives a number of parameters of the swipe gesture, including but not limited to the starting point, the ending point, and the instant points resulted from constant or periodical monitoring. The computer system can conduct calculations based on the detection of the swipe gesture and determine what actions or operations should be conducted.

As shown in step 102 of FIG. 1, in response to detecting the swipe gesture, the computer system may identify, among a list of objects, an object based on the starting point of the swipe gesture.

The object may refer to any virtual informational item, entity, unit, creature, or character in an application program, such as a social networking or communication program, an online game, or a shopping program. The object list may refer to a list of a collection or categories of objects. For example, an object can be contact information for an individual in a contact list, a hyperlink to certain content where the hyperlink is listed with a number of other hyperlinks, or a posting in a list of postings. In some embodiments, the object may have one or more functions and may allow the object to interact with other objects. For example, the object may be a character in a gaming program.

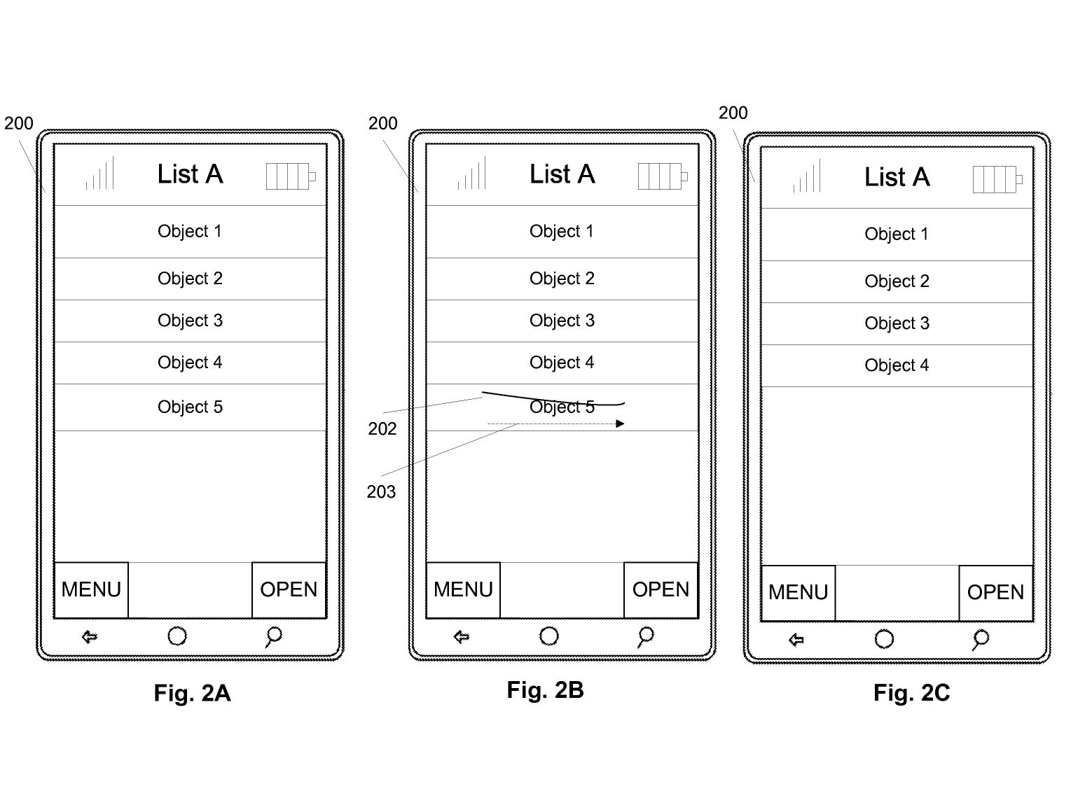

Referring to FIG. 2A, which shows a touch screen 200 displaying an object list—List A. List A includes five objects—Objects 1-5, which, for the purpose of illustration, can be considered hyperlinks or postings, where a simple click of the object results in display of more detailed contents of the object.

In some embodiments, the touch screen may be a rectangular or close-to-rectangular shape having, in generate, a left end, a right end, a top end and a bottom end, as shown in FIG. 2A. However, it should be noted that the shape of the touch screen may vary according to the specific device and the display area of the object list may vary according to the specific device and/or the program displaying the object list. In some embodiments, the object list may be displayed, for example, in a circular or oval display area or an area with irregular shape.

The swipe gesture can be detected by any hardware internal or external of the computer system. For example, sensors such as pressure sensor, displacement sensor, and directional sensor can be used.

As shown in FIG. 2A, the objects displayed on the touch screen may span from the left of the touch screen to the right of the touch screen. However, it should also be noted that the orientation, shape and size of the object may vary according to the nature of the object and/or the program displaying the object. In some embodiments, the displayed object is large enough for an entire swipe gesture to be conducted on the object. Such an approach may provide more security for the operation to be performed for the object according to some embodiments of the current application.

Based on the starting point of the swipe gesture, the computer system may determine a target object. In some embodiments, the starting point of the swipe gesture corresponds to a starting coordinate, which can be a single coordinate or a collection of coordinates corresponding to an area, which can be used to locate the target object based on the object's coordinates. In some embodiments, the starting point falls within the object and the target object is identified because the starting coordinate is included in the object's coordinates. In some embodiments, the starting point only partially overlaps with the object. In some embodiments, the starting point is outside the object but the target object can be identified through an approximation process.

FIG. 2A and FIG. 2B show the touch screen 200 displaying the object list, List A, which includes five objects. Objects 1-5 are listed from top to bottom as one to five, with Object 5 at the bottom. The trace 202 in FIG. 2B indicates the trajectory of the swipe gesture, with the starting point on the left of the touch screen 200 and the ending point on the right of the touch screen 200. Based on the starting point, which falls within Object 5, the computer system identifies Object 5, which is listed in List A, as the target object to which certain operations can be performed. As indicated above, it is not required that the starting point falls within the identified object.

Step 102 of FIG. 1 also indicates that: the computer system can identify a direction of the swipe gesture on the touch screen and a preset operation corresponding to the direction.

FIG. 2B shows that the computer system can identify direction 203 based on the trace 202. In general, neither the trace 202 nor the direction 203 is shown on the touch screen. The direction 203 can be deduced from the trace 202 based on approximation processes. In some embodiments, there are only a limited number of directions for a specific object, a specific program, a specific operating system, or a combination thereof. For example, a communication program may only allow four directions to be identified: left to right, right to left, top to bottom, and bottom to top. In addition, for certain object, e.g. Objects in List A, there may be only two allowable directions: left to right and right to left. The specifics of the trace 202 may vary and the direction 203 may be obtained through an approximation process.

Based on the direction, the computer system may identify a preset operation that can be performed to the identified object. In some embodiments, the preset operation is a default setup in the program. In some embodiments, the preset operation can be customized by the user. In some embodiments, each direction has a corresponding preset operation, which may or may not be changed by the user.

The operation refers to actions that can be taken against an identified object. For example, the operation may be: deletion, bookmarking, adding to another list, hiding, setting to top of list, setting to bottom of list, changing feature, e.g. change to unread, ignoring, highlighting, changing playing section, page turning, or a combination thereof, or other actions. Generally, two operations are of the same nature if the two operations conduct essentially the same action only with positional or quantitative differences. For example, a swipe gesture may be used to drag a playing indicator for an audio or video player and change the time point of the contents being played. However, a left-to-right swipe gesture, which corresponds to dragging forward, and a right-to-left swipe gesture, which corresponds to dragging backward, both result in operations of the same nature. In addition, for example, turning pages or sections forward and backward are operations of the same nature. On the other hand, two operations, such as deletion vs. setting to top, deletion vs. bookmarking, or hiding vs. highlighting, can be considered operations of different nature because they result in changes to the object that are not only positional or quantitative.

In some embodiments, the operations corresponding to swipe gesture can be roughly categorized as negative-impacting or positive-impacting. For example, operations such as but not limited to deletion, ignoring, hiding, setting to bottom list can be considered negative-impacting to the target object. Operations such as but not limited to adding to list, setting to top of list, and highlighting can be considered positive-impacting to the target object. Operations such as but not limited to changing feature can be considered neutral-impacting. In some embodiments, positive-impacting operations are associated with right-to-left swipe gestures because right-to-left physical gestures are commonly related to most people's habit of obtaining an object. In some embodiments, negative-impacting operations are associated with left-to-right swipe gestures because left-to-right physical gestures are commonly related to most people's habit of throwing an object.

In some embodiments, the existence of a swipe gesture and the direction of the swipe gesture can be determined by the positions/coordinates of the starting point and ending point. When the entire swipe gesture is on the target object, the existence of a swipe gesture that can trigger an operation can be determined if the starting point and ending point are in designated areas of the object. Consequently, the direction of the swipe gesture can be determined by which areas the starting point and the ending point belong to. The operations corresponding to the directions can also be determined according to the areas. For example, Table 1 shows the operations, directions, and swipe gestures that can be associated.

TABLE 1

| Preset Operations | Swipe Gesture | |
|---|---|---|
| Deletion | Direction | From left to right |
| | Starting Point | Area A on the left of the object |
| | Ending Point | Area B on the right of the object |
| Set to top | Direction | From right to left |
| | Starting Point | Area C on the right of the object |
| | Ending Point | Area D on the left of the object |

As indicated in Table 1, an object may have area A on the left part of the object and area B on right part of the object. If a swipe gesture has a starting point in area A and an ending point in area B, then the direction of the swipe gesture can be determined as from left to right and the operation, e.g. deletion, associated with the direction of the swipe gesture can be conducted if other conditions are met. Similarly, an object may have area C on the right part of the object and area D on the left part of the object. If a swipe gesture has a starting point in area D and an ending point in area D, then the direction of the swipe gesture can be determined as from right to left and an operation, e.g. set to top of a list, can be conducted according to the direction of the swipe gesture. In some embodiments, for an object, area A can be the same as area D and area B can be the same as area C.

In some embodiments, the areas used to define the swipe gesture are not on the objects, but are in proximity of the objects. For example, area A can be to the left of the object but outside the object; area B can be to the right of the object but outside the object. A swipe gesture with a starting point in area A and ending point in area B have a direction from left to right and a corresponding operation can be conducted to the object.

As shown by step 102 of FIG. 1, the computer system may measure a distance of the swipe gesture between the starting point and the ending point. The distance can be used as a parameter in determining whether an operation should be performed. In some embodiments, the computer system measure the distance by utilizing the coordinates of the starting point and the ending point. For example, the (x, y) coordinates of the starting point (e.g. xₛ and yₛ) and the ending point (xₑ and yₑ) may be acquired by the computer system and the distance between the starting coordinate and ending coordinate can be calculated by D²=(xₑ−xₛ)²+(yₑ−yₛ)². In some embodiments, when the direction is determined, only the coordinate on the direction will be used for calculating the distance. For example, if the direction is determined to be horizontal (e.g. left to right or right to left), the distance can be calculated by D²=(xₑ−xₛ)², wherein the y coordinate is ignored. Similarly, if the direction is determined to be vertical (e.g. top to bottom or bottom to top), the distance can be calculated by D²=(yₑ−yₛ)², wherein the x coordinate is ignored. When the swipe gesture, the direction of the swipe gesture, and the corresponding operation are determined by the areas of the starting point and the ending point, the distance of the starting point and ending point can be determined as a fixed value between the areas.

As shown by step 103 of FIG. 1, the computer system may perform an operation if the distance is longer than a first preset value. In some embodiments, the performance of the operation does not require additional authorization from the user. In some embodiments, the operation is a first operation if the distance is longer than a first preset value and the direction of the swipe gesture is in a first direction. On the other hand, the operation is a second operation if the distance is longer than the first preset value and the direction of the swipe gesture is in a second direction. In some embodiments, the first and second directions are opposite directions.

In some embodiments, the first operation and the second operation are of different natures. For example, the first operation and the second operation, which are different, are independently selected from the group including but not limited to: deletion, bookmarking, adding to another list, hiding, setting to top of list, changing to unread, ignoring, highlighting, changing playing section, page turning, and a combination thereof. These operations are of different natures and the first operation and the second operation are different. The first operation and the second operation are not two operations conduct essentially the same action only with positional or quantitative differences. For example, the first operation and the second operation are not dragging a play indicator forward and backward, or turning a page or section forward and backward.

The first preset value is a threshold value for the distance. When the distance is greater than the first preset value, the computer system performs the operation. Otherwise, the operation is cancelled or altered. The first preset value can be determined by the program or by modifying a default value by the user.

FIG. 2C shows the resulting screen shot after the operation has been performed. In this case, the operation is deletion or hiding and the operation is performed on Object 5. The computer system determines to perform the operation without further authorization based on the distance of the starting point and ending point. When the distance is greater than the first preset value, the operation is performed and Object 5 is deleted or hidden—thus touch screen 200 is not displaying Object 5 in FIG. 2C.

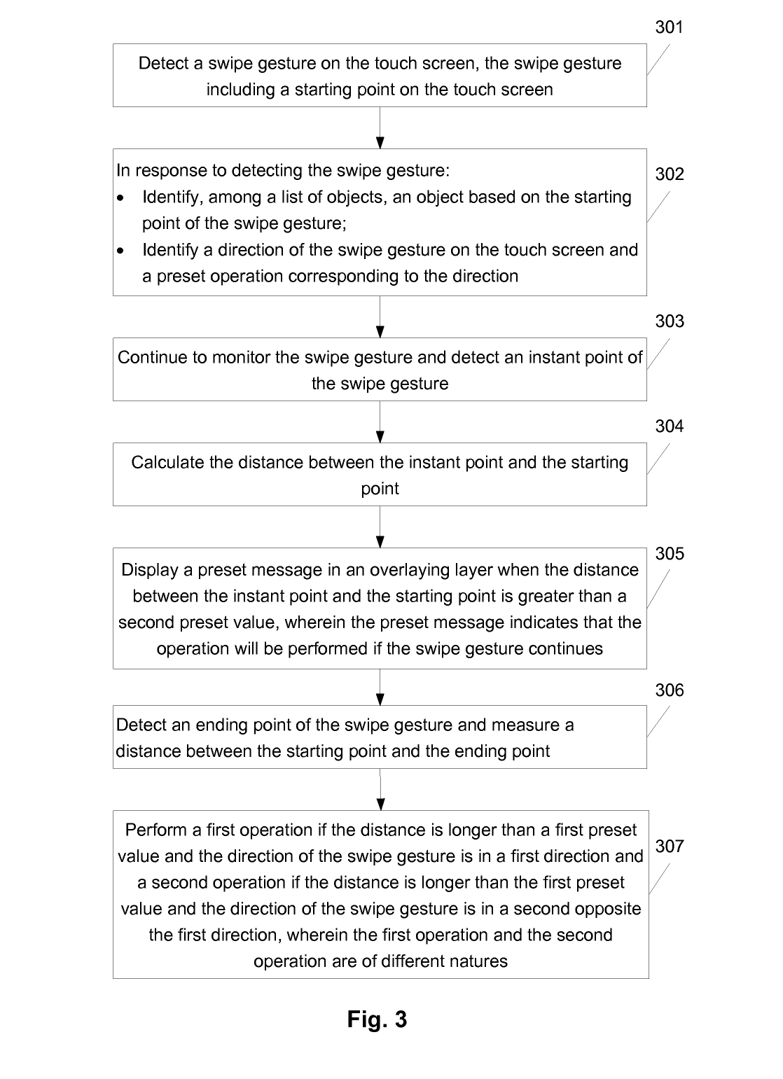

FIG. 3 is a flowchart illustrative of a method for performing operations on an object in accordance with some embodiments of the current application.

As shown in step 301 of FIG. 3, the computer system may detect a swipe gesture on the touch screen, wherein the swipe gesture includes a starting point on the touch screen.

As shown in step 302 of FIG. 3, in response to detecting the swipe gesture, the computer system may identify, among a list of objects, an object based on the starting point of the swipe gesture. In addition, the computer system may identify a direction of the swipe gesture on the touch screen and a preset operation corresponding to the direction.

As shown in step 303 of FIG. 3, the computer system may continue to monitor the swipe gesture and detect an instant point of the swipe gesture. The instant point reflects the instant position of the touch point of the swipe gesture. In some embodiments, the instant point corresponds to instant coordinates, which are constantly changing based on the movement of the swipe gesture until the swipe gesture is ended. In some embodiments, the monitoring may be conducted in a periodical manner, e.g. every 5 milliseconds.

As shown in step 304 of FIG. 3, the computer system may calculate the distance between the instant point and the starting point. In some embodiments, the calculation is conducted in a periodical manner. As indicated by step 102 of FIG. 1, the distance between the instant point the starting point may use the coordinates of the instant point and starting point, with or without considering the direction of the swipe gesture.

As shown in step 305 of FIG. 3, the computer system may display a preset message in an overlaying layer when the distance between the instant point and the starting point is greater than a second preset value. The second preset value is a threshold distance that can be used to determine whether certain actions, e.g. displaying a warning, should be taken before the operation on the object is performed.

In some embodiments, the preset message indicates that the operation will be performed if the swipe gesture continues. In some embodiments, the preset message can be displayed on an overlaying layer or a masking panel.

In some embodiments, the distance between the instant point and the starting point can be determined by pre-defined areas as indicated above. For example, an object has area A on the left of the object, area B in the middle of the object, and area C on the right of the object. When a swipe gesture has a starting point in area A and when the instant point reaches area B, the direction is determined as from left to right and the preset message is displayed. If the ending point is in area C, the corresponding operation is performed. If the user changes his/her mind and the ending point is not located within area C, then no operation is conducted.

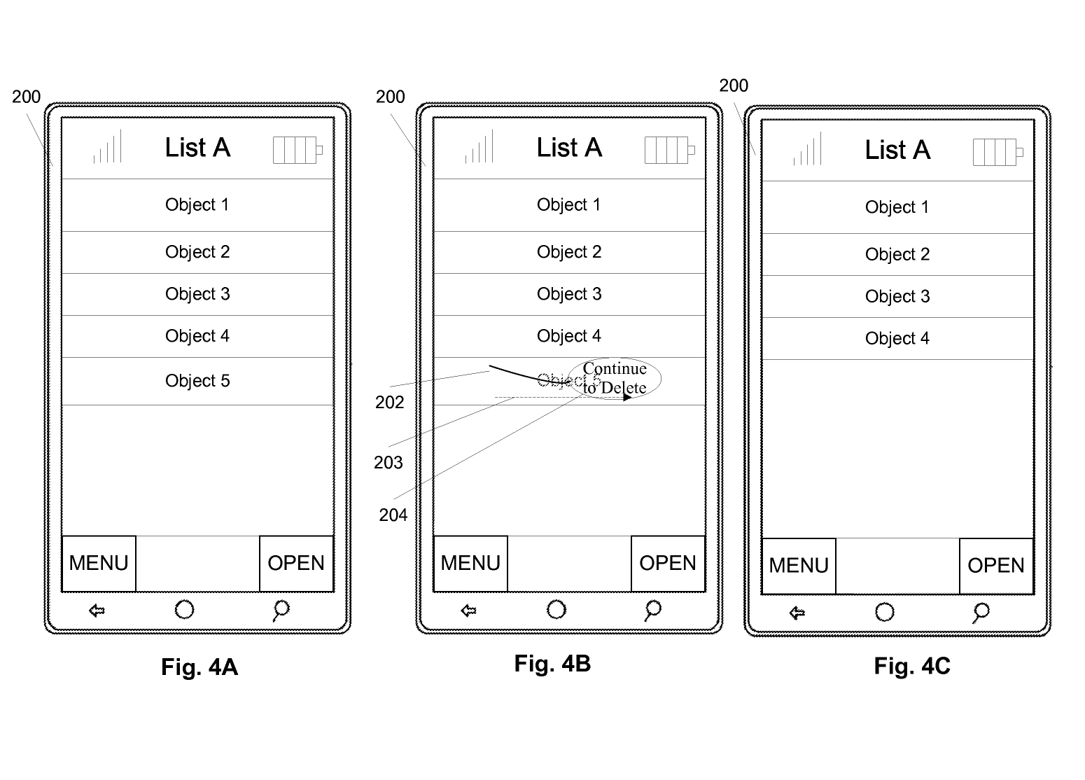

FIGS. 4A and 4B show a touch screen 200 displaying an object list—List A, which includes Objects 1-5. As shown in FIG. 4B, swipe gesture 202 is detect by the computer system, which determines the target object—Object 5, a direction 203 and an operation based on the direction 203. The computer system monitors the swipe gesture 202 by acquiring the instant point of the swipe gesture 202 and calculating the distance between the instant point and the starting point. When the distance becomes greater than a preset value—the second preset value, the computer system displays a preset message 204.

In some embodiments, as shown in FIG. 4B, the preset message 204 is “continue to delete” and the preset message is presented on an overlaying layer having oval shape. It should be noted that the contents of the preset message and the specific design of the overlaying layer may vary according to the operation that has been determined and the needs of the program and the user. In some embodiments, the preset message provides a warning or notice to the user that certain operations will be performed to the object if the swipe gesture continues. Because no further authorization will be requested, the preset message allows the user to determine whether the operation will be performed eventually. In some embodiments, the target object has a sufficient width or length to allow the entire swipe gesture to take place on the object. In addition, the sufficient width or length also allows the user to have enough time to determine whether the operation should be performed.

In some embodiments, the overlaying layer is partially transparent. Such an approach allows the user to see the object clearly, which can be partly covered by the overlaying layer. In some embodiments, the overlaying layer is entirely within the displayed object, as shown in FIG. 4B. In this case, it is easier for the user to see which object will be affected by the operation if the operation is performed. In some embodiments, the shape, size, color and/or design of the overlaying layer may vary based on the operation. For example, a left-to-right swipe gesture can result in a deletion, which is shown in a message in an oval overlaying layer; a right-to-left swipe gesture can result in a “set to top” operation, which is shown in a rectangular overlaying layer. With such an approach, the user may not need to clearly see the warning message every time. If the user is familiar with the operations and the associated overlaying layer, seeing an oval or rectangular layer may provide sufficient notice to the user.

As shown by step 306 of FIG. 3, the computer system may detect an ending point of the swipe gesture and measure a distance between the starting point and the ending point. In some embodiments, the ending point corresponds to the point on the touch screen when the touching object, e.g. a finger tip, is lifted or when the swipe gesture extends beyond the touch screen. With the coordinates of the ending point, a distance between the starting point and ending point can be calculated.

As shown in step 307 of FIG. 3, the computer system may perform a first operation if the distance is longer than a first preset value and the direction of the swipe gesture is in a first direction and a second operation if the distance is longer than the first preset value and the direction of the swipe gesture is in a second opposite the first direction, wherein the first operation and the second operation are of different natures. The first preset value is a threshold for determining whether the operation should be performed. In some embodiments, the first preset value is greater than the second preset value so that the preset message can be display before the operation is performed. As indicated, the direction of the swipe gesture and the operation can also be determined by pre-defined areas.

FIG. 4C shows the results of the swipe gesture when the distance between the starting point and ending point is greater than the first preset value and the operation is performed. As indicated in FIG. 4B, the operation is deletion. Therefore, the completion of the operation resulted in deletion of the identified objection—Object 5. In some embodiments, the deleted object is moved to a section or folder specifically for deleted objects. In some embodiments, the deleted objects can be recovered. For example, as soon as an object is deleted, the deleted object can be recovered by a process essentially similar to the steps of FIGS. 4A and 4B, except that the direction of the swipe gesture opposite to FIG. 4B and the starting point is on the blank area of the object list, e.g. the area below Object 4. Such an approach can also allow the user to recover the last-deleted object, providing a remedy for accidental deletion.

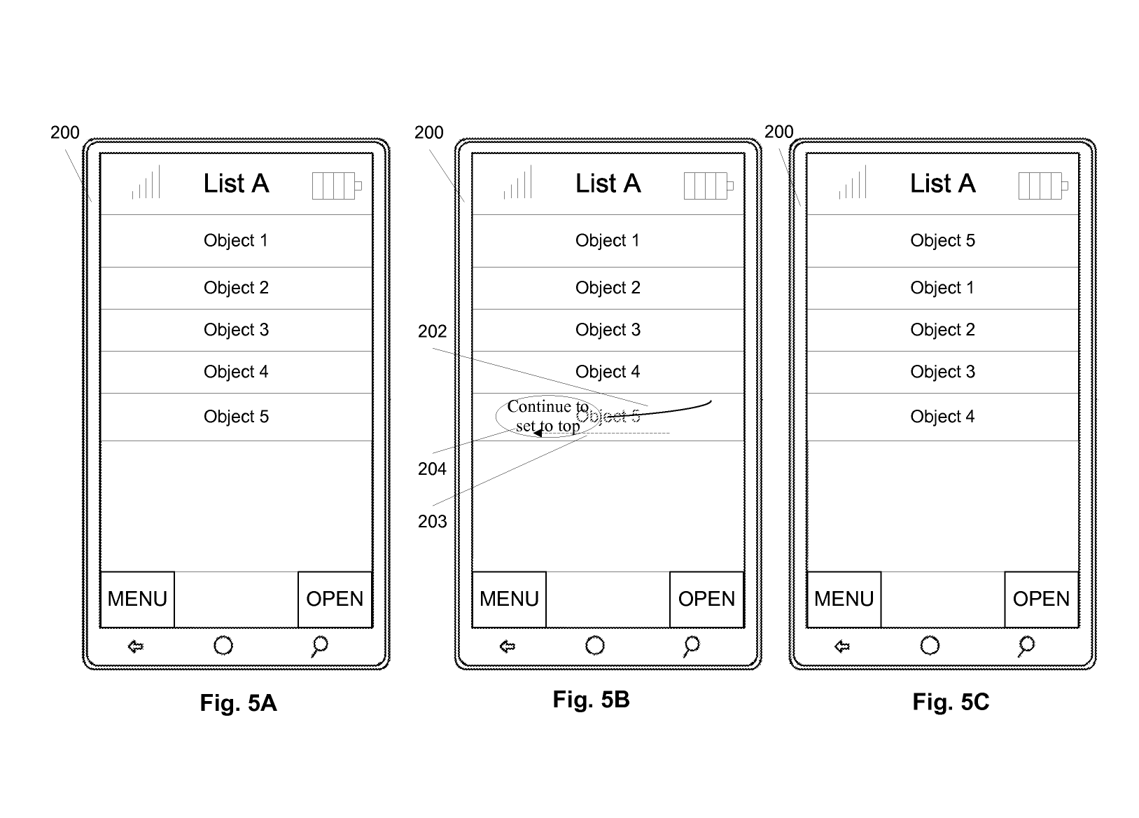

As indicated, based on the direction of the swipe gesture, the associated operation can be different. For example, as shown in FIGS. 5A, 5B and 5C, a different operation is performed on Object 5. FIG. 5A shows the touch screen 200 displaying an object list—List A, which includes Objects 1-5. As shown in FIG. 5B, a swipe gesture 202 is detected and the computer system determines a direction 203 for the swipe gesture 202. In the embodiment shown in FIG. 5B, the direction is from right to left. The computer system identifies the target object—Object 5 based on the starting point of the swipe gesture 202 and an operation based on the direction 203. The computer system continues to monitor the swipe gesture 202 and calculates the distance between the instant point and the starting point. When the distance between the instant point and the starting point is greater than a second preset value, the computer system displays a preset message 204 on an overlaying layer to provide notice to the user that Object 5 will be set to top if the swipe gesture continues. The swipe gesture 202 and the preset message 204 are entirely in the displayed object—Object 5. In addition, the overlaying layer is partially transparent, allowing the user to see the target object and understand which object will be affected by the operation. FIG. 5C shows the results of the swipe gesture 202 when the swipe gesture 202 is completed. The computer system detects an ending point for the swipe gesture 202 and measures the distance between the starting point and the ending point. When the distance between the starting point and the starting point is greater than a first preset value, the identified operation—setting to top—is performed to Object 5. As shown in FIG. 5C, Object 5 is now on the top position of List A after the operation is performed.

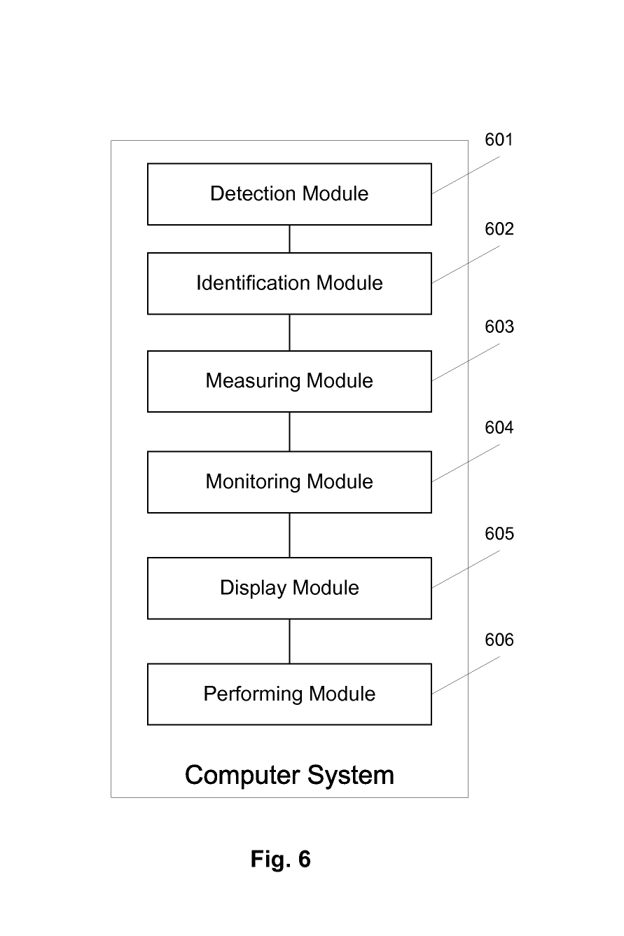

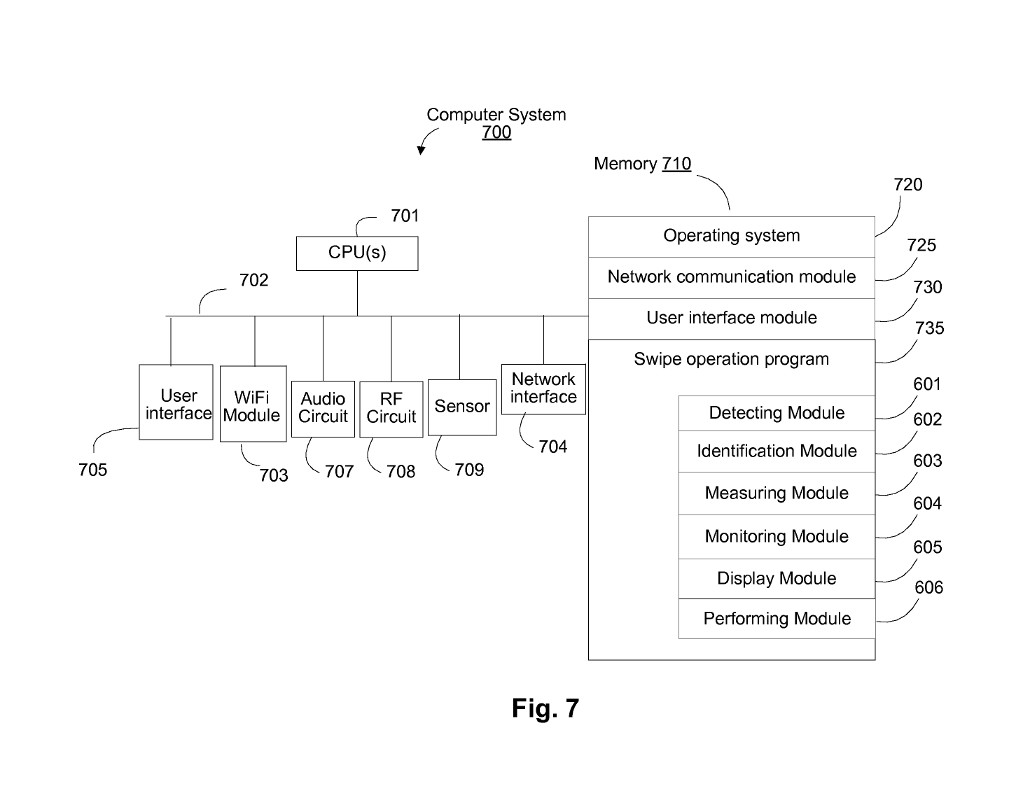

FIG. 6 and FIG. 7 illustrate the computer systems that may be used to perform the methods described above. To avoid redundancy, not all the details and variations described for the method are herein included for the devices. Such details and variations should be considered included for the description of the devices as long as they are not in direct contradiction to the specific description provided for the device.

FIG. 6 is a block diagram illustrative of a computer system that can be used in performing an operation on an object based on a swipe gesture in accordance with some embodiments of the current application. As shown in FIG. 6, the computer system may comprise: a detection module 601, an identification module 602, a measuring module 603, a monitoring module 604, a display module 605, and a performing module 606.

In some embodiments, the detection module 601 is configured to detect a swipe gesture on the touch screen, the swipe gesture including a starting point on the touch screen and an ending point on the touch screen.

In some embodiments, the identification module 602 is configured to identify, among a list of objects, an object based on the starting point of the swipe gesture, and a direction of the swipe gesture on the touch screen and a preset operation corresponding to the direction, in response to detecting the swipe gesture. The operation may include but not be limited to: deletion, bookmarking, adding to another list, hiding, setting to top of list, changing feature, e.g. change to unread, ignoring, highlighting, changing playing section, page turning, or a combination thereof.

In some embodiments, the measuring module 603 is configured to measure a distance of the swipe gesture between the starting point and the ending point.

In some embodiments, the performing module 606 is configured to perform a first operation if the distance is longer than a first preset value and the direction of the swipe gesture is in a first direction and a second operation if the distance is longer than the first preset value and the direction of the swipe gesture is in a second direction opposite the first direction, wherein the first operation and the second operation are of different natures. In some embodiments, the first direction is from the left of the touch screen to the right of the touch screen, and the second direction is from the right of the touch screen to the left of the touch screen.

In some embodiments, the monitoring module 604 is configured to monitor the swipe gesture before the ending point is reached. The monitoring module 601 can be configured to detect an instant point of the swipe gesture. In addition, the measuring module 603 can be configured to measure the distance between the instant point and the starting point.

In some embodiments, the display module 605 is configured to display a preset message in an overlaying layer when the distance between the instant point and the starting point is greater than a second preset value but less than the first preset value.

In some embodiments, the preset message indicates that an operation will be performed if the swipe gesture continues. In some embodiments, the overlaying layer moves with the swipe gesture. In some embodiments, the identified object spans from the left of the touch screen to the right of the touch screen. In some embodiments, the overlaying layer is partially transparent and covers part of the object.

FIG. 7 is a block diagram of a computer system 700 in accordance with some embodiments of the present application. The computer system 700 typically includes one or more processing units (CPU's) 701, one or more network or other communications interfaces 704, memory 710, and one or more communication buses 702 for interconnecting these components. The communication buses 702 may include circuitry (sometimes called a chipset) that interconnects and controls communications between system components. The computer system 700 may also include an RF (Radio Frequency) circuit 708, sensors 709, an audio circuit 707, and a WiFi (Wireless Fidelity) module 703. The computer system 700 may include a user interface 705, e.g. a touch, which is both a display and an input device. Those skilled in the art may understand that the computer system 700 is not limited to the structures shown in FIG. 7, and it may comprise more or fewer parts than those in FIG. 7. In addition, some parts may be combined, or different arrangement of parts may be adopted therein.

The RF circuit 708 may be used for receiving and sending a signal during transferring of information or calling, and particularly may be used for sending information of from base station to one or more processors 701 for processing after receiving the downlink information, and sending uplink data to the base station. Generally, the RF circuit 708 comprises, but not limited to, an antenna, at least one amplifier, a tuner, one or more oscillators, an SIM (Subscriber Identity Module) card, a transceiver, a coupler, an LNA (Low Noise Amplifier), a duplexer and the like. Furthermore, the RF circuit 708 also can communicate with other equipment by wireless communication and/or the network. The wireless communication may be used with any communication standards or protocols which include, but not limited to, GSM (Global System of Mobile Communication), a GPRS (General Packet Radio Service), CDMA (Code Division Multiple Access), WCDMA (Wideband Code Division Multiple Access), LTE (Long Term Evolution), E-mail, and SMS (Short Messaging Service).

The user interface 705 may be used for receiving input number or character information and generating signal input related to user's setting and functional control, from keyboard, mouse, operating rod, optical or trackball. Particularly, the user interface may comprise a touch screen and other input equipment. The touch screen may also be named a touch control panel and may be used for detecting touch operations (for example, operations carried out by the user by using any suitable objects or attachments, such as a finger, a touch pen and the like, on the touch screen or near the touch screen) of the user on the touch screen or near the touch screen and driving corresponding apparatus connected therewith according to a preset program. In some embodiments, the touch screen may comprise a touch detection apparatus and a touch controller. The touch detection apparatus may be used for detecting the touch direction of the user, detecting a signal caused by the touch operation and transmitting the signal to the touch controller. The touch controller may be used for receiving the touch information from the touch detection apparatus, converting the touch information into contact coordinates and then sending the contact coordinates to the processor 701 and may also receive a command sent by the processor 701 and execute the command. Moreover, the touch screen may be implemented in various types such as a resistance type, a capacitance type, an infrared type, a surface acoustic wave type and the like. Besides the touch screen, the user interface 705 also may include other input equipments. Particularly, other input equipments may include, but not limited to, one or more of physical keyboards, virtual (function) keys (such as volume control key, switching key and the like), trackballs, mouse, operating rods and the like.

The computer system 700 also may include at least one sensor 709, such as optical sensors, motion sensors and other sensors. Particularly, the optical sensors may include an environmental light sensor and a proximity sensor. The environmental light sensor may regulate brightness of the touch screen according to the lightness of environmental light. The proximity sensor may shut down the touch screen and/or backlight when the computer system 700 is moved to the position near an ear. As one of the motion sensors, the gravity acceleration sensor may detect the value of an acceleration in each of the directions (generally, three directions or three axes), and may detect the value and the direction of gravity in a static state, which may be used for posture identifying functions (such as switching between a horizontal screen and a vertical screen, switching related to a game, and calibration on the posture of a magnetometer), vibration identifying functions (such as for pedometer and striking) and the like, in the computer system. Furthermore, a gyroscope, a barometer, a humidity meter, a thermometer, an infrared sensor and other sensors may be integrated into the computer system 700.

The audio circuit 707 may include a speaker and a microphone that can provide an audio interface between the user and the computer system 700. The audio circuit 707 may transmit an electric signal obtained by converting received audio data to the speaker. The electric signal is converted into a sound signal to be output by the speaker. On the other hand, the microphone converts a collected sound signal into an electric signal. The audio circuit 707 receives the electric signal and converts the electric signal into audio data. After the audio data is output to the processor 701 and is processed, it is sent, for example, to another computer system through the RF circuit 708, or is output to the memory 710 in order to be further processed. The audio circuit 707 also possibly includes an earphone jack for providing communication between an external earphone and the computer system 700.

WiFi belongs to the technology of short distance wireless transmission. With the WiFi module 703, the computer system 700 may help the user to receive and send emails, browse webpages, access streaming media and the like. The WiFi module 703 provides wireless broadband internet access for the user. Although the WiFi module 703 is shown in FIG. 7, it should be understood that the WiFi module 703 is not the necessary component of the computer system 700 and may be omitted as not required without change of the scope of the application.

The processor 701 is a control center of the computer system 700 and it is connected with the other parts of the computer system by various interfaces and lines and is used for executing various operations of the computer system 700 and processing the data by operating the software programs and/or the modules stored in the memory 710, and accessing the data stored in the memory 710 so as to carry out integral monitoring on the computer system. In some embodiments, the processor 701 may comprise one or more processing chips. In some embodiments, an application processor and a modulation-demodulation processor may be integrated into the processor 701, wherein the application processor is mainly used for the operating system, the user interface, applications and the like, and the modulation-demodulation processor is mainly used for wireless communication. It should be understood that the modulation-demodulation processor also may be not integrated into the processor 701.

The computer system 700 also includes the power supply (such as a battery) for supplying power to each part. In some embodiments, the power supply may be logically connected with the processor 701 by a power supply management system so as to implement functions of charge management, discharge management, power consumption management and the like by the power supply management system. The power supply also may include any components such as one or more DC (Direct Current) or AC (Alternating Current) power supplies, recharging systems, power supply fault detection circuits, power supply converters or inverters, power supply state indicators and the like.

The computer system 700 also may include a camera, a Bluetooth module and the like although they are not shown in FIG. 7.

Memory 710 may include high speed random access memory and may also include non-volatile memory, such as one or more magnetic disk storage devices. Memory 710 may include mass storage that is remotely located from the CPU's 701. In some embodiments, memory 710 stores the following programs, modules and data structures, or a subset or superset thereof:
an operating system 720 that includes procedures for handling various basic system services and for performing hardware dependent tasks;
a network communication module 725 that is used for connecting the computer system 700 to other computers via one or more communication networks (wired or wireless), such as the Internet, other wide area networks, local area networks, metropolitan area networks, and so on;
a user interface module 730 configured to receive user inputs through the user interface 705;
and a number of terminal-side application modules 735 including the following:
a detection module 601 configured to detect a swipe gesture on the touch screen, the swipe gesture including a starting point on the touch screen and an ending point on the touch screen;
an identification module 602 is configured to identify, among a list of objects, an object based on the starting point of the swipe gesture, and a direction of the swipe gesture on the touch screen and a preset operation corresponding to the direction, in response to detecting the swipe gesture. The operation may include but not be limited to: deletion, bookmarking, adding to another list, hiding, setting to top of list, changing feature, e.g. change to unread, ignoring, highlighting, changing playing section, page turning, or a combination thereof;
a measuring module 603 configured to measure a distance of the swipe gesture between the starting point and the ending point;
a performing module 606 configured to perform a first operation if the distance is longer than a first preset value and the direction of the swipe gesture is in a first direction and a second operation if the distance is longer than the first preset value and the direction of the swipe gesture is in a second direction opposite the first direction, wherein the first operation and the second operation are of different natures. In some embodiments, the first direction is from the left of the touch screen to the right of the touch screen, and the second direction is from the right of the touch screen to the left of the touch screen;
a monitoring module 604 configured to monitor the swipe gesture before the ending point is reached. The monitoring module 601 can be configured to detect an instant point of the swipe gesture. In addition, the measuring module 603 can be configured to measure the distance between the instant point and the starting point; and
a display module 605 configured to display a preset message in an overlaying layer when the distance between the instant point and the starting point is greater than a second preset value but less than the first preset value.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

What is claimed is:

1. A method for performing operations to an object displayed on a touch screen of a computer system, comprising:
at the computer system having one or more processors and memory storing programs executed by the one or more processors,
detecting a swipe gesture on the touch screen, the swipe gesture including a starting point on the touch screen and an ending point on the touch screen;
in response to detecting the swipe gesture:
identifying, among a list of objects, an object based on the starting point of the swipe gesture;
identifying a direction of the swipe gesture on the touch screen and a preset operation corresponding to the direction;
measuring a distance of the swipe gesture between the starting point and the ending point; and
performing a first operation if the distance is longer than a first preset value and the direction of the swipe gesture is in a first direction and a second operation if the distance is longer than the first preset value and the direction of the swipe gesture is in a second direction opposite the first direction, wherein the first operation and the second operation are of different natures.

2. The method of claim 1, wherein:
the first direction is from the left of the touch screen to the right of the touch screen, and
the second direction is from the right of the touch screen to the left of the touch screen.

3. The method of claim 1, wherein:
the first operation is deleting the object and the second operation is re-positioning the object to the top of a list.

4. The method of claim 1, further comprising:
monitoring the swipe gesture and detecting an instant point of the swipe gesture.

5. The method of claim 4, further comprising:
calculating the distance between the instant point and the starting point, and
displaying a preset message in an overlaying layer when the distance between the instant point and the starting point is greater than a second preset value but less than the first preset value.

6. The method of claim 5, wherein:
the preset message indicates that an operation will be performed if the swipe gesture continues.

7. The method of claim 5, wherein:
the overlaying layer moves with the swipe gesture.

8. The method of claim 5, wherein:
the identified object spans from the left of the touch screen to the right of the touch screen.

9. The method of claim 8, wherein:
the overlaying layer is partially transparent and covers part of the object.

10. A computer system, comprising:
a touch screen;
one or more processors;
memory; and
one or more program modules stored in the memory and configured for execution by the one or more processors, the one or more program modules including:
a detection module configured to detect a swipe gesture on the touch screen, the swipe gesture including a starting point on the touch screen and an ending point on the touch screen;
an identification module configured to identify, among a list of objects, an object based on the starting point of the swipe gesture, and a direction of the swipe gesture on the touch screen and a preset operation corresponding to the direction, in response to detecting the swipe gesture;
a measuring module configured to measure a distance of the swipe gesture between the starting point and the ending point; and
a performing module configured to perform a first operation if the distance is longer than a first preset value and the direction of the swipe gesture is in a first direction and a second operation if the distance is longer than the first preset value and the direction of the swipe gesture is in a second direction opposite the first direction, wherein the first operation and the second operation are of different natures.

11. The computer system of claim 10, wherein:
the first direction is from the left of the touch screen to the right of the touch screen, and
the second direction is from the right of the touch screen to the left of the touch screen.

12. The computer system of claim 10, wherein:
the first operation is deleting the object and the second operation is re-positioning the object to the top of a list.

13. The computer system of claim 10, further comprising:
a monitoring module configured to monitor the swipe gesture and detect an instant point of the swipe gesture.

14. The computer system of claim 13, wherein:
the measuring module is further configured to calculate the distance between the instant point and the starting point, and the computer system further comprises:
a display module configured to display a preset message in an overlaying layer when the distance between the instant point and the starting point is greater than a second preset value but less than the first preset value.

15. The computer system of claim 14, wherein:
the preset message indicates that an operation will be performed if the swipe gesture continues.

16. The computer system of claim 14, wherein:
the overlaying layer moves with the swipe gesture.

17. The computer system of claim 14, wherein:
the identified object spans from the left of the touch screen to the right of the touch screen.

18. The computer system of claim 17, wherein:
the overlaying layer is partially transparent and covers part of the object.

19. A non-transitory computer readable storage medium having stored therein one or more instructions, which, when executed by a computer system, cause the computer system to:
detect a swipe gesture on the touch screen, the swipe gesture including a starting point on the touch screen and an ending point on the touch screen;
in response to detecting the swipe gesture:
identify, among a list of objects, an object based on the starting point of the swipe gesture;
identify a direction of the swipe gesture on the touch screen and a preset operation corresponding to the direction;
measure a distance of the swipe gesture between the starting point and the ending point; and
perform a first operation if the distance is longer than a first preset value and the direction of the swipe gesture is in a first direction and a second operation if the distance is longer than the first preset value and the direction of the swipe gesture is in a second direction opposite the first direction, wherein the first operation and the second operation are of different natures.

20. The non-transitory computer readable storage medium of claim 19, wherein the instructions further cause the computer system to:
monitor the swipe gesture and detect an instant point of the swipe gesture;
calculate the distance between the instant point and the starting point; and
display a preset message in an overlaying layer when the distance between the instant point and the starting point is greater than a second preset value but less than the first preset value, wherein
the preset message indicates that an operation will be performed if the swipe gesture continues, and
the overlaying layer moves with the swipe gesture.
